(19) United States
(12) Patent Application Publication
(10) Pub. No.: US 2025/0253474 A1
(43) Pub. Date: Aug. 7, 2025

(54) BRACKET ASSEMBLY, BATTERY RACK AND ENERGY STORAGE CONTAINER

(71) Applicant: EVE ENERGY STORAGE CO., LTD, WUHAN (CN)

(72) Inventors: WEIJUN LU, WUHAN (CN); MENGCHUN WANG, WUHAN (CN)

(21) Appl. No.: 19/002,757

(22) Filed: Dec. 27, 2024

(30) Foreign Application Priority Data
Feb. 3, 2024 (CN) 202420266169.0

(51) Int. Cl. H01M 50/264; H01M 50/204; H01M 50/244

(52) U.S. Cl. CPC H01M 50/264; H01M 50/244; H01M 50/204

(57) ABSTRACT

A bracket assembly, a battery rack and an energy storage container are provided. The battery rack main body is provided with multiple layers of battery storage areas for placing battery packs. The bracket assembly includes a plurality of first brackets configured to support and fix the battery packs. Each of the battery storage areas is mounted with a plurality of the first brackets. The plurality of the first brackets in the same battery storage area are arranged in multiple columns and multiple rows. Two adjacent first brackets in the same row are arranged in a staggered manner, so that two adjacent battery packs in the same row are arranged in a staggered manner.

### CROSS-REFERENCE TO RELATED APPLICATION(S)

The present disclosure claims priority to Chinese Patent Application No. 202420266169.0, filed on Feb. 3, 2024, the disclosure of which is incorporated herein by reference in its entirety.

### TECHNICAL FIELD

The present disclosure relates to the technology field of batteries, and in particular, to a bracket assembly, a battery rack and an energy storage container.

### BACKGROUND

An energy storage container integrates a battery energy storage system into a container, so as to store and release electric energy. The energy storage container mainly includes two parts: an electrical compartment and a battery compartment. The electrical compartment is mainly placed with a power distribution cabinet, an inverter, etc., in order to be able to better control circuits. While the battery compartment is mainly placed with battery packs, which are fixedly arranged on a bracket, so as to protect the battery packs from being damaged by an external impact.

In the related technologies, a bracket in the energy storage container and used for supporting the battery is usually arranged across the container directly, and is only suitable for installing the battery packs with relatively small sizes.

In the related technologies, as the capacity of the battery pack increases, the size of the battery pack is also increased. However, the size and internal space of a standard container are usually fixed, resulting in a reduction in the number of battery packs that can be installed in the container, and even a battery pack with an increased size cannot be installed in the container.

### SUMMARY

In a first aspect, the present disclosure provides a bracket assembly, which is employed in a battery rack. The battery rack further includes a battery rack main body. The battery rack main body is provided with multiple layers of battery storage areas for placing battery packs. The bracket assembly includes a plurality of first brackets. The plurality of first brackets are arranged in the multiple layers of battery storage areas, where each of the battery storage areas is mounted with a plurality of the first brackets. The plurality of the first brackets in a same battery storage area are arranged in multiple columns and multiple rows, and configured to support and fix a plurality of the battery packs. Two adjacent first brackets in the same row are arranged in a staggered manner, so that two adjacent battery packs in the same row are provided in a staggered manner.

In a second aspect, the present disclosure provides a battery rack, including a battery rack main body and the bracket assembly provided in the above first aspect of the present disclosure. The battery rack main body is provided with multiple layers of bracket mounting layers. Two adjacent layers of bracket mounting layers enclose to form a battery storage area. A top surface and a bottom surface of the same bracket mounting layer are respectively provided with a plurality of first brackets. The first bracket located on the top surface of one bracket mounting layer in the same battery storage area is configured to install one side of the battery pack, and the first bracket located on the bottom surface of the other bracket mounting layer in the same battery storage area is configured to install an opposite side of the battery pack.

In a third aspect, the present disclosure provides an energy storage container, including a plurality of battery packs and the battery rack provided in the second aspect of the present disclosure. The plurality of battery packs are provided on a battery rack.

### BRIEF DESCRIPTION OF THE DRAWINGS

FIG. 1 is a schematic structural diagram of a bracket assembly provided by some embodiments of the present disclosure;

FIG. 2 is an enlarged diagram of the structure at an area A in FIG. 1;

FIG. 3 is an enlarged diagram of the structure at an area B in FIG. 1;

FIG. 4 is a schematic structural diagram of a first bracket provided by some embodiments of the present disclosure;

FIG. 5 is an enlarged diagram of the structure at an area C in FIG. 4;

FIG. 6 is a schematic diagram of a first partial assembly structure of a battery rack provided by some embodiments of the present disclosure;

FIG. 7 is a schematic diagram of a second partial assembly structure of battery rack provided by some embodiments of the present disclosure;

FIG. 8 is an exploded schematic diagram of a first bracket and a battery pack provided by some embodiments of the present disclosure;

FIG. 9 is a schematic diagram of the structure shown in FIG. 8 viewed from another perspective;

FIG. 10 is a schematic diagram of the structure shown in FIG. 8 viewed from another perspective;

FIG. 11 is a schematic structural diagram of a battery rack provided by some embodiments of the present disclosure.

### REFERENCE NUMERALS IN THE DRAWINGS

1, energy storage container; 10, battery rack; 100, battery rack main body; 101, support frame; 102, bracket mounting layer; 103, high-voltage box layer; 110, battery storage area; 12, bracket assembly; 20, first bracket; 201, first end; 202, second end; 210, first panel; 220, second panel; 222, snap fitting member; 2222, first snap fitting section; 2224, second snap fitting section; 230, third panel; 240, fourth panel; 234, limiting slot; 250, connecting portion; 260, avoidance portion; 30, cushioning member; 40, support block; 50, battery pack; 501, bottom surface; 502, top surface; 503, first end; 504, second end; 510, battery pack main body; 520, support plate; 522, first protrusion; 524, snap fitting slot; 526, second protrusion.

### DETAILED DESCRIPTION

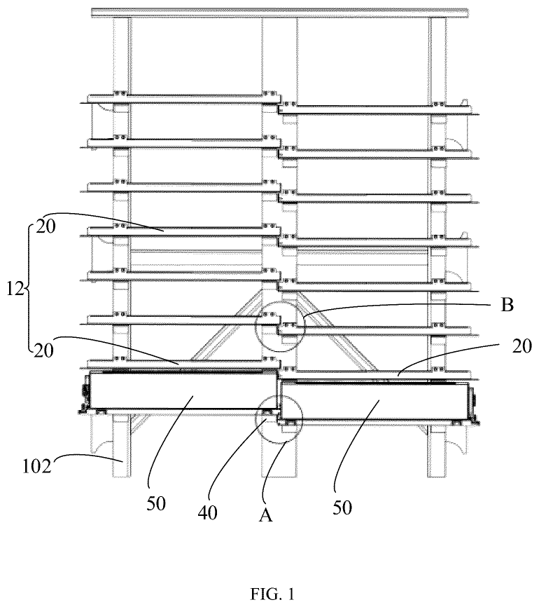

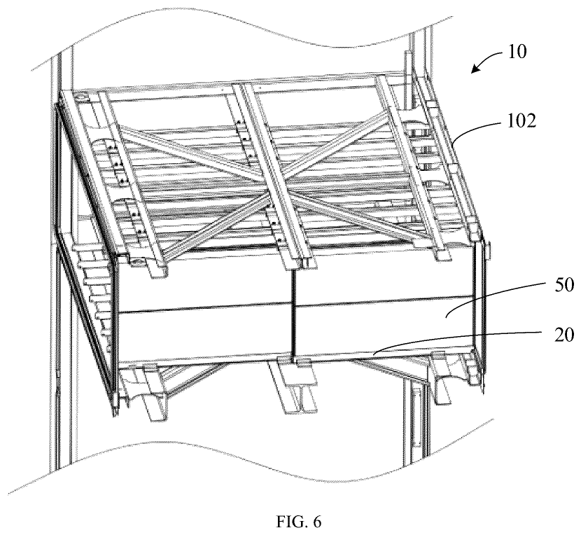

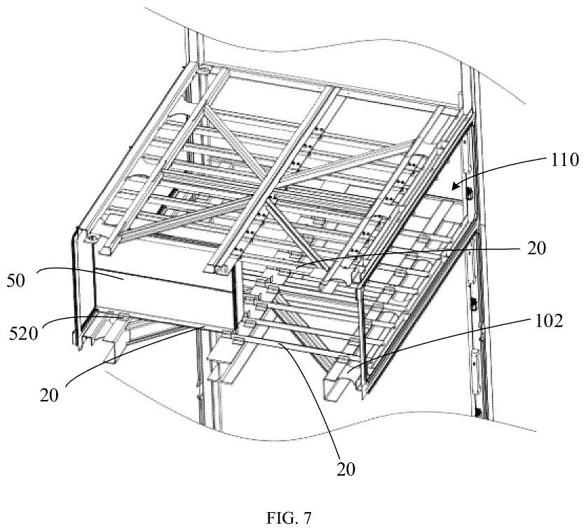

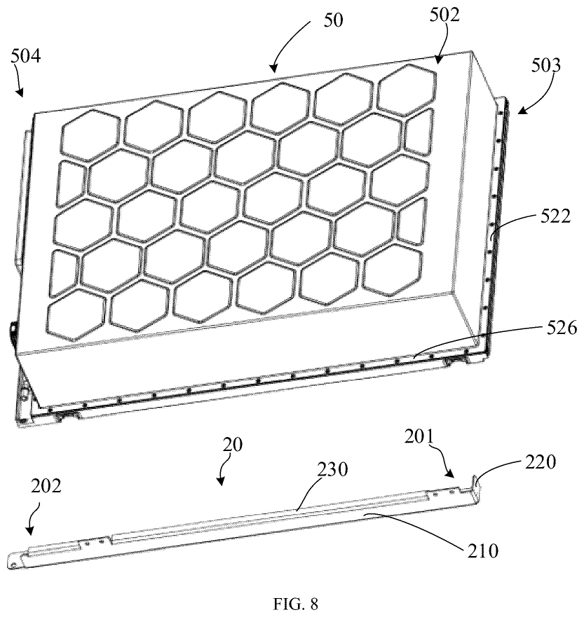

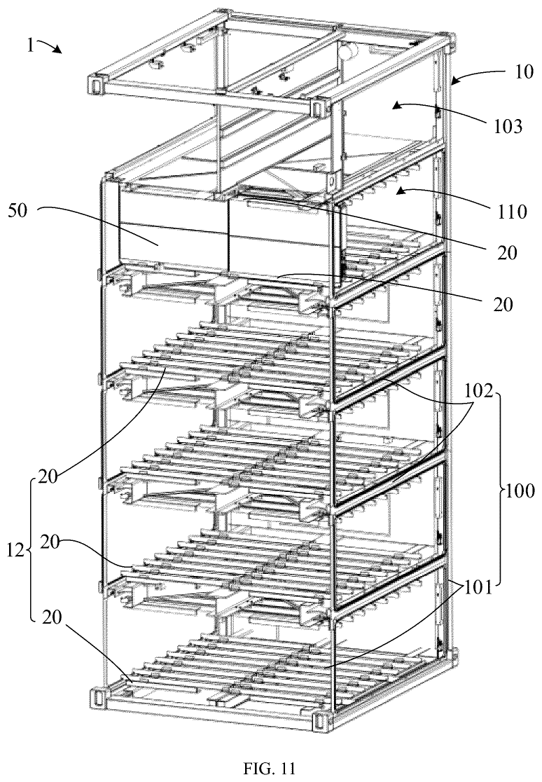

In some embodiments, as shown in FIG. 1, FIG. 6, FIG. 7, and FIG. 11, a bracket assembly 12 applied to a battery rack 10 is provided. The battery rack 10 can be configured to place, support, and fix a plurality of battery packs 50. The battery rack 10 further includes a battery rack main body 100. The battery rack main body 100 can be divided into multiple layers, for example, the battery rack main body 100 is provided with multiple layers of battery storage areas 110, and each of the battery storage areas 110 is configured to place a plurality of battery packs 50. The bracket assembly 12 includes a plurality of first brackets 20. The first brackets 20 are configured to support and fix the battery packs 50. The plurality of first brackets 20 are arranged in the multiple layers of battery storage areas 110 respectively. Each of the battery storage areas 110 is mounted with a plurality of the first brackets 20, and the plurality of first brackets 20 in the same battery storage area 110 are arranged in multiple columns and multiple rows. Two adjacent first brackets 20 in the same row are arranged in a staggered manner, so that two adjacent battery packs 50 in the same row are arranged in a staggered manner.

The battery rack main body 100 can also be provided with a high-voltage box layer 103. The high-voltage box layer 103 can be located on the top of the battery rack main body 100. The battery packs 50 may formed by coupling a plurality of battery modules in series. The battery module may be a battery module of a single-row cell group, a battery module of a double-row cell group, or a battery module of a multi-row cell group. The cell group may be formed by coupling a plurality of cells in series or in parallel. In some embodiments, the cell may be a lithium cell.

In some embodiments, the number of the first brackets 20 arranged in each layer of the battery storage areas 110 is the same. The first bracket 20 may be arranged in the corresponding battery storage area 110 by means of welding, or screwing, etc.

For example, the first bracket 20 is of a long strip structure. Due to the plurality of the first brackets 20 in the same battery storage area 110 being arranged in multiple columns and multiple rows, with two adjacent first brackets 20 in the same row being arranged in a staggered manner, and two adjacent first brackets 20 in the same column being arranged at intervals, when the plurality of battery packs 50 are placed on the corresponding first brackets 20, the plurality of battery packs 50 in the same battery storage area 110 are arranged in multiple columns and multiple rows, and two adjacent battery packs 50 in the same row are arranged in a staggered manner.

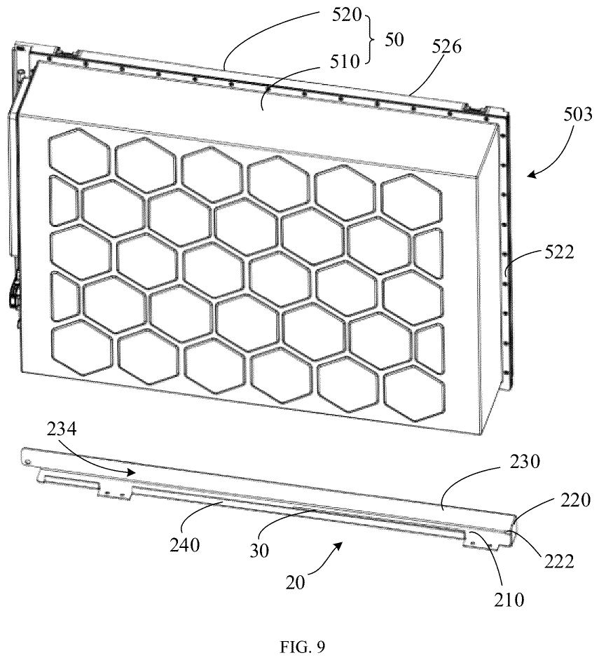

In some embodiments, as shown in FIG. 8 to FIG. 10, the battery pack 50 is a convex battery pack 50. A bottom surface 501 of the battery pack 50 is in a rectangular shape, a top surface 502 of the battery pack 50 is in a rectangular shape, and the area of the bottom surface 501 of the battery pack 50 is larger than the area of the top surface 502 of the battery pack 50. Edges of the bottom surface 501 of the battery pack 50 is provided on the first bracket 20. By means of staggered arrangement of two adjacent first brackets 20 in the same row, the edges of the bottom surfaces 501 of two adjacent battery packs 50 in the same row are arranged in a staggered manner. In an example, the plurality of first brackets 20 in the same column in the same battery storage area 110 are parallel to each other, and the plurality of first brackets 20 in the same row in the same battery storage area 110 are parallel to each other.

As shown in FIG. 4 and FIG. 8, the first bracket 20 includes a first end 201 and a second end 202 opposite to each other. The battery pack 50 includes a first end 503 and a second end 504 opposite to each other. In some embodiments, during an installation of the battery pack 50, the first end 503 of the battery pack 50 is first placed on the second end 202 of the first bracket 20, then a user applies a pushing force to the second end 504 of the battery pack 50, causing the first end 503 of the battery pack 50 to advance from the second end 202 of the first bracket 20 toward the first end 201 of the first bracket 20, until the first end 503 of the battery pack 50 abuts against the first end 201 of the first bracket 20, thereby achieving the installation and fixation of the battery pack 50.

In the battery rack 10 of the present embodiment, the battery rack main body 100 is provided with multiple layers of battery storage areas 110, each layer of battery storage areas 110 is provided with a plurality of first brackets 20, the plurality of first brackets 20 in the same battery storage area 110 are arranged in multiple columns and multiple rows, and two adjacent first brackets 20 in the same row are arranged in a staggered manner, so that two adjacent battery packs 50 in the same row are arranged in a staggered manner, which is more conducive to adapting the battery packs 50 to standard containers without modifying the structure of the battery packs 50. Moreover, in the embodiments of the present disclosure, by means of staggered arrangement of two adjacent first brackets 20 in the same row, and arranging the battery packs 50 and the first brackets 20 in a matched manner, it is ensured that each first bracket 20 can be placed with the battery packs 50. Furthermore, by means of the staggered arrangement of the two adjacent first brackets 20 in the same row, one of the two adjacent battery packs 50 in the same row is also placed in a staggered manner relative to the other battery pack 50, so as to reduce the overall installation length of the two adjacent battery pack 50 in the same row, allow the battery packs 50 with longer lengths to be adapted to standard containers, and improve the universality of the standard containers.

In some embodiments, as shown in FIG. 8 and FIG. 9, the battery pack 50 includes a battery pack main body 510 and a support plate 520. The battery pack main body 510 is arranged on the support plate 520. The support plate 520 is provided with a first protrusion 522 protruding from the battery pack main body 510 and located at the first end 503 of the battery pack 50. That is, a panel area of the support plate 520 is larger than a bottom area of the battery pack main body 510, thus, the support plate 520 and the battery pack main body 510 constitute the battery pack 50 with a convex structure. The first protrusions 522 of two adjacent battery packs 50 in the same row are staggered. It should be noted that liquid cooling channels may be provided in the support plate 520, and the support plate 520 may also be configured to cool and dissipate heat of the battery pack 50.

Due to the first protrusion 522 of the support plate 520 protruding from the battery pack main body 510, during an installation of the battery pack 50, one end of the support plate 520 of the battery pack 50 providing with the first protrusion 522 is first placed on the second end 202 of the first bracket 20, then a user applies a pushing force to the second end 504 of the battery pack 50, causing the first end 503 of the battery pack 50 to advance from the second end 202 of the first bracket 20 toward the first end 201 of the first bracket 20, until the first protrusion 522 of the support plate 520 abuts against the first end 201 of the first bracket 20, thereby achieving the installation of the battery pack 50.

By staggered arrangement of two adjacent first brackets 20 in the same row, when two battery packs 50 are placed on two adjacent first brackets 20 in the same row, the first protrusion 522 of one of the battery packs 50 is provided on the first protrusion 522 of the other battery pack 50 in a staggered manner (i. e. the bottom edge of one of the convex-type structure battery packs 50 is placed on the bottom edge of the other convex-type structure battery pack 50), achieving the staggered arrangement of two battery packs 50, and reducing the overall installation length of the two adjacent battery packs 50 in the same row, allowing battery packs 50 with longer lengths to be adapted to standard containers, and improving the universality of the standard containers. It should be noted that a staggered distance between the two adjacent first brackets 20 in the same row is determined by a protrusion size of the first projections 522 of the battery pack 50.

In an example, the protrusion size of the first protrusion 522 is greater than or equal to the staggered distance between the two adjacent first brackets 20 in the same row, to ensure that the first protrusions 522 of the two adjacent battery packs 50 in the same row can both abut against the first ends 201 of the corresponding first brackets 20, and to increase the overlap length between the first protrusions 522 of the two battery packs 50, thereby reducing the overall length of the two battery packs 50. Specifically, when the support plate 520 of the battery pack 50 is placed on the first bracket 20, and the first protrusion 522 of the support plate 520 abuts against the first end 201 of the first bracket 20, the battery packs 50 on the two adjacent first brackets 20 in the same row are arranged in a staggered manner, that is, the first protrusions 522 of one battery pack 50 are arranged in a staggered manner relative to the first protrusions 522 of the other battery pack 50, allowing the two adjacent first brackets 20 in the same row to placed with two battery packs 50 with longer dimensions.

In some embodiments, as shown in FIG. 8 and FIG. 9, the support plate 520 is further provided with a second protrusion 526 protruding from the battery pack main body 510 and located at a side of the battery pack 50. The second protrusion 526 is connected to the first protrusion 522. In some embodiments, the support plate 520 is a rectangular structure, the first protrusion 522 is located at a first short side in a length direction of the support plate 520, and the second protrusion 526 is located at a first long side in the width direction of the support plate 520.

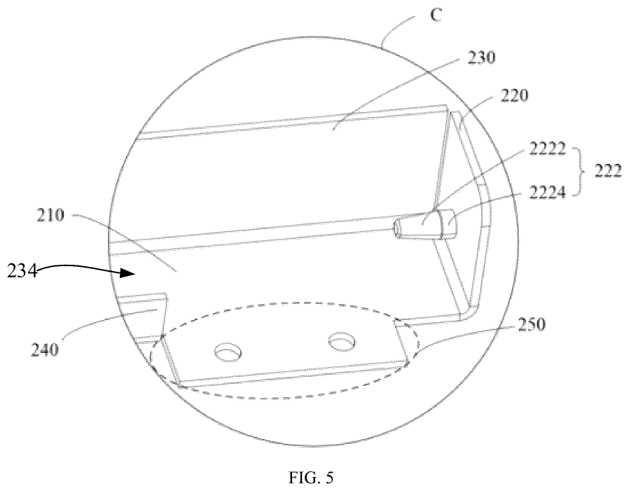

In some embodiments, as shown in FIG. 4 and FIG. 5, the first bracket 20 is provided with a first panel 210 and a second panel 220.

The first bracket 20 may be a bracket made of metal materials. The first panel 210 is an elongated panel extending along a length direction of the first bracket 20. The first panel 210 may be configured to support a side of the battery pack 50 provided with the second protrusion 526. The second panel 220 is provided at the first end 201 of the first bracket 20 and is bent with respect to the first panel 210. The second panel 220 may be configured to abut against the first end 503 of the battery pack 50 provided with the first protrusion 522. For example, the second panel 220 is vertically connected to a first end of the first panel 210. In an example, the first panel 210 may be provided with a guiding groove (not shown), and the second protrusion 526 of the battery pack 50 is provided in cooperation with the guiding groove of the first panel 210, such that the second protrusion 526 of the battery pack 50 is able to be pushed to move along the guiding groove of the first panel 210. Specifically, the first panel 210 is configured to support the second protrusion 526, and the second panel 220 is configured to abut against the first protrusion 522. In some embodiments, in two adjacent first brackets 20 in a same row, the second panel 220 of one first bracket 20 is parallel to the second panel 220 of the other first bracket 20.

In the embodiment where the first support 20 includes the second panel 220, the plurality of the first support members 20 in the same battery storage area 110 are arranged in two columns and multiple rows, and the first ends 201 of two adjacent first support members 20 in the same row are close to each other and arranged in a staggered manner. In the embodiment where the first bracket 20 does not include the second panel 220, the plurality of first brackets 20 in the same battery storage area 110 may be arranged in two or more columns.

As shown in FIG. 1 to FIG. 3, by staggered arrangement of the two adjacent first brackets 20 in the same row, the second panel 220 of one first bracket 20 is arranged in a staggered manner relative to the second panel 220 of the other first bracket 20. During the installation process of the battery pack 50, one end of the second protrusion 526 of the battery pack 50 near the first protrusion 522 is first placed on a second end of the first panel 210, then a user applies a pushing force to the second end 504 of the battery pack 50, causing the first end 503 of the battery pack 50 to advance from the second end of the first panel 210 toward the first end of the first panel 210, until the first protrusion 522 of the battery pack 50 abuts against the second panel 220, so that the battery pack 50 is limited and fixed, thereby achieving the installation of the battery pack 50 on the first bracket 20, and arranging the second protrusions 526 of the two adjacent battery packs 50 in the same row in a staggered manner, which allows the battery packs 50 with longer lengths to be adapted to standard containers, and improves the universality of the standard containers.

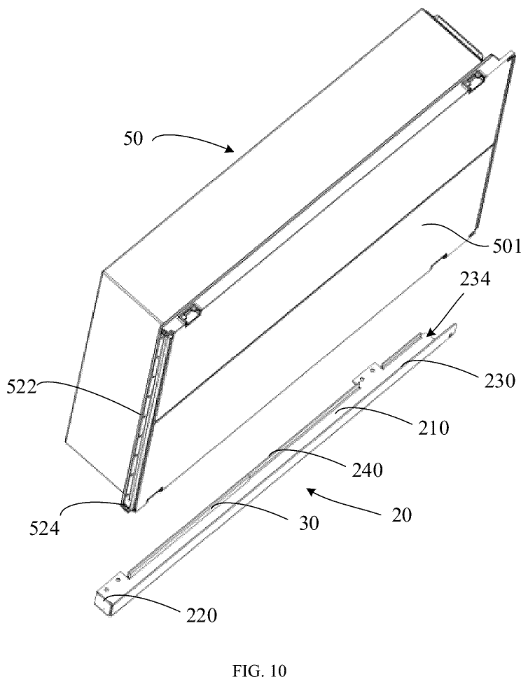

In some embodiments, as shown in FIG. 4 and FIG. 5, the second panel 220 is provided with a snap fitting member 222. The snap fitting member 222 is configured to snap fit with a snap fitting slot 524 (as shown in FIG. 10) provided on the first end 503 of the battery pack 50.

The snap fitting member 222 may be provided on the second panel 220 by means of welding, or screwing, etc. In another example, the snap fitting member 222 and the second panel 220 are an integrated structure.

During the installation process of the battery pack 50, one end of the second protrusion 526 of the battery pack 50 near the first protrusion 522 is first placed on the second end of the first panel 210, then a user applies a pushing force to the second end 504 of the battery pack 50, causing the first end 503 of the battery pack 50 to advance from the second end of the first panel 210 toward the first end of the first panel 210, until the snap fitting slot 524 of the battery pack 50 is snapped to the snap fitting member 222 of the second panel 220, so that the first end 503 of the battery pack 50 is limited and fixed on the second panel 220, thereby enhancing the firmness and convenience of the installation of the battery pack 50, and preventing the first end 503 of the battery pack 50 from loosening.

In some embodiments, as shown in FIG. 10, the first protrusion 522 on the first end 503 of the battery pack 50 is provided with the snap fitting slot 524 corresponding to the snap fitting member 222. The first protrusion 522 of the battery pack 50 is snap-fitted to the snap fitting member 222 of the second panel 220 through the snap fitting slot 524, so as to limit and fix the first protrusion 522 on the second panel 220.

In some embodiments, as shown in FIG. 5, the snap fitting member 222 includes a first snap fitting section 2222 and a second snap fitting section 2224. A second end of the first snap fitting section 2222 is connected to a first end of the second snap fitting section 2224, and a second end of the second snap fitting section 2224 is provided on the second panel 220. A first end of the first snap fitting section 2222 is smaller in size than the second end of the first snap fitting section 2222.

The first snap fitting section 2222 and the second snap fitting section 2224 are an integrated structure, the first snap fitting section 2222 may be of a tapered structure, and the second snap fitting section 2224 may be of a columnar structure. For example, the first snap fitting section 2222 is of a conical structure, the second snap fitting section 2224 is of a cylindrical structure. The snap fitting slot 524 on the first protrusion 522 of the battery pack 50 is larger in size than the first end of the first snap fitting section 2222, so that the first snap fitting section 2222 serves as a guide for insertion, which facilitates the insertion of the clamping slot 524 on the first protrusion 522 of the battery pack 50 into the snap fitting member 222 on the second panel 220.

During the installation process of the battery pack 50, one end of the second protrusion 526 of the battery pack 50 near the first protrusion 522 is first placed on the second end of the first panel 210, then a user applies a pushing force to the second end 504 of the battery pack 50, causing the first end 503 of the battery pack 50 to advance from the second end of the first panel 210 toward the first end of the first panel 210, and at the same time the snap fitting slot 524 on the first protrusion 522 of the battery pack 50 is aligned with the first snap fitting section 2222 of the second panel 220, and then the snap fitting slot 524 on the first protrusion 522 of the battery pack 50 is inserted into the snap fitting member 222 of the second panel 220, so as to limit and fix the first protrusion 522 of the battery pack 50 on the second panel 220, that is, limit and fix the first end 503 of the battery pack 50 on the second panel 220 of the first bracket 20, which enhances the firmness and convenience of the installation of the battery pack 50.

In some embodiments, as shown in FIG. 4, FIG. 5, and FIG. 10, the first bracket 20 is further provided with a third panel 230 and a fourth panel 240. The third panel 230, the fourth panel 240 and the first panel 210 enclose to form a limiting slot 234. The limiting slot 234 is configured to guide the battery pack 50 to move toward the second panel 220 during an installation of the battery pack 50, so that the snap fitting slot 524 on the first end 503 of the battery pack 50 is snapped into the snap fitting member 222 of the second panel 220.

The third panel 230 is an elongated panel extending along the length direction of the first bracket 20, the fourth panel 240 is an elongated panel extending along the length direction of the first bracket 20. The third panel 230 and the first panel 210 are an integrated structure, and the fourth panel 240 and the first panel 210 are an integrated structure. That is, the third panel 230 and the fourth panel 240 are bent from two opposite sides of the first panel 210. In some embodiments, the third panel 230 is perpendicular to the first panel 210, the fourth panel 240 is perpendicular to the first panel 210, and the third panel 230 is parallel to the fourth panel 240.

Due to the third panel 230, the fourth panel 240 and the first panel 210 enclosing to form the limiting slot 234, and the second protrusion 526 of the battery pack 50 being provided within the limiting slot 234, the second protrusion 526 of the battery pack 50 can be limited by the limiting slot 234.

During the installation process of the battery pack 50, one end of the second protrusion 526 of the battery pack 50 near the first protrusion 522 is first placed in the limiting slot 234, then a user applies a pushing force to the second end 504 of the battery pack 50, causing the second protrusion 526 of the battery pack 50 to advance along the limiting slot 234 from the second end of the first panel 210 toward the first end of the first panel 210, so that the snap fitting slot 524 on the first protrusion 522 of the battery pack 50 is aligned with the snap fitting member 222 of the second panel 220, and then the snap fitting slot 524 on the first protrusion 522 of the battery pack 50 is inserted into the snap fitting member 222 of the second panel 220, so as to limit and fix the first protrusion 522 of the battery pack 50 on the second panel 220, that is, limit and fix the first end 503 of the battery pack 50 on the second panel 220 of the first bracket 20, which enhances the firmness and convenience of the installation of the battery pack 50.

In some embodiments, as shown in FIG. 10, the first bracket 20 further includes a cushioning member 30. The cushioning member 30 is provided on an inner wall of at least one of the third panel 230 and the fourth panel 240, and the cushioning member 30 is located between the inner wall and the battery pack 50.

The cushioning member 30 may be, but not limited to, a foam sheet.

For example, the cushioning member 30 may be provided on the inner wall of the third panel 230 or the inner wall of the fourth panel 240 by means of adhesive bonding, after the second protrusion 526 of the battery pack 50 is placed in the limiting slot 234, the cushioning member 30 may cushion the second protrusion 526 of the battery pack 50, so that when the user applies a pushing force to the second end 504 of the battery pack 50 to cause the second protrusion 526 of the battery pack 50 to advance along the limiting slot 234 from the second end of the first panel 210 toward the first end of the first panel 210, the second protrusion 526 of the battery pack 50 can be prevented from being directly pressed or touched by the third panel 230 or the fourth panel 240. In another example, the inner wall of the third panel 230 and the inner wall of the fourth panel 240 are each provided with the cushioning member 30, so that when the user applies a pushing force to the second end 504 of the battery pack 50 to cause the second protrusion 526 of the battery pack 50 to advance along the limiting slot 234 from the second end of the first panel 210 toward the first end of the first panel 210, the cushioning member 30 on the third panel 230 and the cushioning member 30 on the fourth panel 240 may simultaneously provide cushioning protection to the second protrusion 526 of the battery pack 50.

In some embodiments, as shown in FIG. 4 and FIG. 5, the first bracket 20 is further provided with a plurality of connecting portions 250 for connecting the first bracket 20 to the battery rack main body 100. The plurality of connecting portions 250 protrude from the first panel 210.

The connecting portion 250 and the first panel 210 are an integrated structure. In some embodiments, the first bracket 20 is provided with two connecting portions 250, where one connecting portion 250 is arranged adjacent to the first end 201 of the first bracket 20, and the other connecting portion 250 is arranged adjacent to the second end 202 of the first bracket 20.

For example, the connecting portion 250 protrudes from the first panel 210, the connecting portion 250 is provided with at least one first mounting hole, and the battery rack main body 100 is provided with a second mounting hole corresponding to the first mounting hole, so that a screw can pass through the first mounting hole of the connecting portion 250 and the second mounting hole of the battery rack main body 100, to lock the connecting portion 250 to the battery rack main body 100, thereby mounting and locking the first bracket 20 on the battery rack main body 100, and at the same time preventing the battery pack 50 mounted on the first bracket 20 from interference.

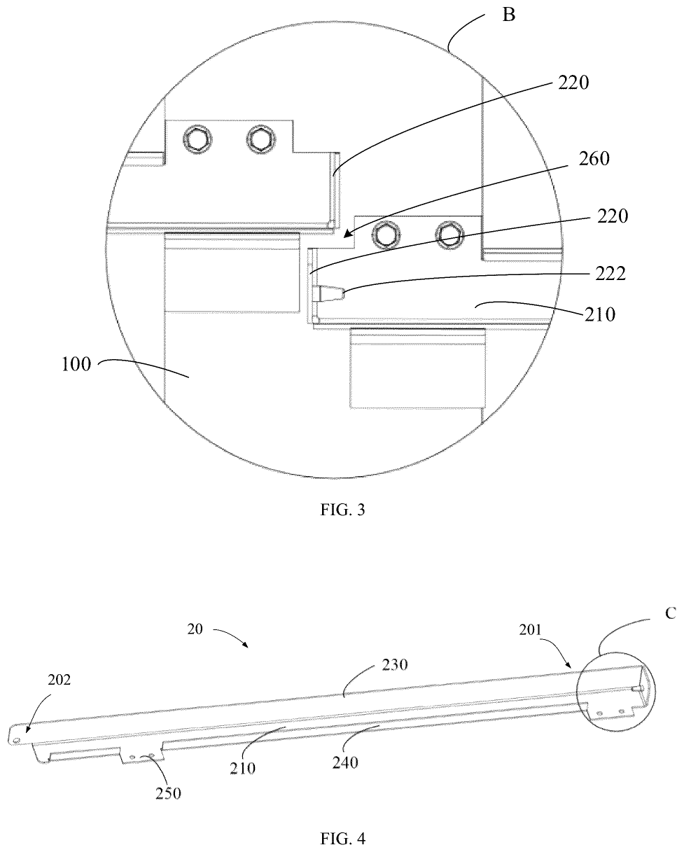

In an example, as shown in FIG. 3, one of the connecting portions 250 is arranged adjacent to the second panel 220. An avoidance portion 260 is formed among the first panel 210, the second panel 220, and the connecting portion 250 adjacent to the second panel 220. The avoidance portion 260 is configured to avoid the adjacent first bracket 20 in a same row.

The avoidance portion 260 is a notch-shaped structure. By arranging the connecting portion 250 adjacent to the second panel 220, and leaving a certain distance between the connecting portion 250 and the end portion of the first panel 210, a notch-shaped structure can be form among the first panel 210, the second panel 220, and the connection 250 adjacent to the second panel 220, that is, the first panel 210, the second panel 220, and the connecting portion 250 adjacent to the second panel 220 are enclosed to form the avoidance portion 260. Thus, the avoidance portion 260 of the first bracket 20 can avoid another adjacent first bracket 20 in the same row, achieving the staggered arrangement of two adjacent first brackets 20 in the same row, improving the compactness of the structure, and avoiding interference with another adjacent first bracket 20 in the same row. By arranging the battery packs 50 and the first brackets 20 in a matched manner, it is ensured that each first bracket 20 can be placed with the battery packs 50. Furthermore, by means of the staggered arrangement of the two adjacent first brackets 20 in the same row, one of the two adjacent battery packs 50 in the same row can be placed in a staggered manner relative to the other battery pack 50, so as to reduce the overall installation length of two adjacent battery pack 50 in the same row, allow the battery packs 50 with longer lengths to be adapted to standard containers, and improve the universality of the standard containers.

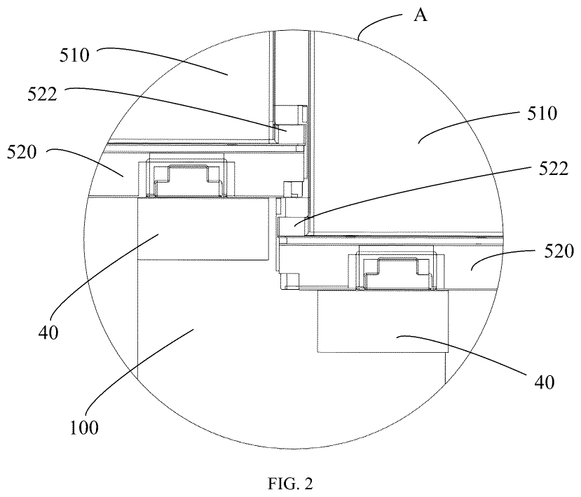

In some embodiments, as shown in FIG. 1 and FIG. 2, the bracket assembly 12 further includes a support block 40. A first end portion of the support block 40 is connected to the battery rack main body 100, and a second end portion of the support block 40 is connected to the first bracket 20.

The support block 40 may be made of a metal material. The first end portion of the support block 40 may be arranged on the battery rack main body 100 by means of welding, or screwing, etc., and the second end part of the support block 40 may be arranged on the first bracket 20 by means of welding, or screwing, etc.

In some embodiments, the support block 40 may be divided into a first support section and a second support section. The first support section and the second support section are an integrated structure. The first end portion of the support block 40 is located on the first support section, and the second end portion of the support block 40 is located on the second support section. In some embodiments, the first support section is perpendicular to the second support section, and a connection portion between the first support section and the second support section is in an arc shape, so that the strength of the support block 40 can be reinforced, the fixing function of the first bracket 20 can be reinforced, and the first bracket 20 can be prevented from being twisted.

In some embodiments, as shown in FIG. 6, FIG. 7 and FIG. 11, a battery rack 10 is further provided, which includes a battery rack main body 100 and the bracket assembly 12 provided by the above embodiments of the present disclosure. The battery rack main body 100 is provided with a support frame 101 and a plurality of bracket mounting layers 102. The plurality of bracket mounting layers 102 are installed parallel to each other on the support frame 101. Two adjacent layers of bracket mounting layers 102 enclose to form the battery storage area 110. A top surface and a bottom surface of the same bracket mounting layer 102 are respectively provided with a plurality of first brackets 20. In some embodiments, as shown in FIG. 8 to FIG. 10, two opposite sides of the support plate 520 are both provided with the second protrusion 526 protruding from the battery pack main body 510. In this way, the first bracket 20 located on the top surface of one bracket mounting layer 102 in the same battery storage area 110 is configured to install the second protrusion 526 provided on one side of the battery pack 50, and the first bracket 20 located on the bottom surface of the other bracket mounting layer 102 in the same battery storage area 110 is configured to install the second protrusion 526 provided on an opposite side of the battery pack 50.

As shown in FIG. 10, the battery rack main body 100 is provided with six layers of bracket mounting layers 102, and two adjacent layers of bracket mounting layers 102 enclose to form the battery storage area 110, that is, the battery rack main body 100 includes five layers of battery storage areas 110. For the detailed description of the bracket assembly 12, reference may be made to the detailed description of the bracket assembly 12 in the above embodiments of the present disclosure, and will not be repeated herein.

The top surface of the same bracket mounting layer 102 is provided with a plurality of first brackets 20, where the plurality of first brackets 20 are arranged in multiple columns and multiple rows, two adjacent first brackets 20 in the same row are arranged in a staggered manner, and two adjacent first brackets 20 in the same column are arranged at intervals. The bottom surface of the same bracket mounting layer 102 is provided with a plurality of first brackets 20, where the plurality of first brackets 20 are arranged in multiple columns and multiple rows, two adjacent first brackets 20 in the same row are arranged in a staggered manner, and two adjacent first brackets 20 in the same column are arranged at intervals. In another example, the bracket mounting layer 102 located at the bottommost layer of the battery rack main body 100 is provided with a plurality of first brackets 20 only on its top surface, without providing the first brackets 20 on its bottom surface. The bracket mounting layer 102 located at the topmost layer of the battery rack main body 100 is provided with a plurality of first brackets 20 only on its bottom surface, without providing the first bracket 20 on its top surface.

When installing the battery pack 50, when the first end 503 of the battery pack 50 is pushed into the battery storage area 110, the first bracket 20 located on the top surface of one bracket mounting layer 102 in the same battery storage area 110 limits and fixes the second protrusion 526 provided on one side of the battery packs 50, the first bracket 20 located on the bottom surface of the other bracket mounting layer 102 in the same battery storage area 110 limits and fixes the second protrusion 526 provided on the other side of the battery pack 50, thus, the battery pack 50 in the battery storage area 110 can be firmly fixed, and the battery pack 50 is prevented from falling due to looseness. In addition, when a plurality of battery packs 50 are provided in a corresponding battery storage area 110, the plurality of battery packs 50 in the same battery storage area 110 are arranged in multiple columns and multiple rows, and two adjacent battery packs 50 in the same row are arranged in a staggered manner, which is more conducive to adapting the battery packs 50 to standard containers without modifying the structure of the battery packs 50.

In the embodiments of the present disclosure, the battery storage area 110 is formed by enclosing two adjacent bracket mounting layers 102. The top surface and the bottom surface of the same bracket mounting layer 102 are respectively provided with a plurality of first brackets 20. The first bracket 20 located on the top surface of one bracket mounting layer 102 in the same battery storage area 110 is configured to install the second protrusion 526 provided on one side of the battery pack 50, and the first bracket 20 located on the bottom surface of the other bracket mounting layer 102 in the same battery storage area 110 is configured to install the second protrusion 526 provided on the other side of the battery pack 50, so that two sides of the battery pack 50 are limited and fixed. By means of the staggered arrangement of two adjacent first brackets 20 in the same row, and matching the two second protrusions 526 of the battery pack 50 with the corresponding first brackets 20, it is ensured that the battery pack 50 is firmly mounted and arranged. Furthermore, by means of the staggered arrangement of two adjacent first brackets 20 in the same row, one of the two adjacent battery packs 50 in the same row is placed in a staggered manner relative to the other battery pack 50, so as to reduce the overall installation length of two adjacent battery pack 50 in the same row, allow the battery packs 50 with longer lengths to be adapted to standard containers, and improve the universality of the standard containers.

In some embodiments, as shown in FIG. 11, an energy storage container 1 is also provided. The energy storage container 1 includes a plurality of battery packs 50 and the battery rack 10 provided in the above embodiments of the present disclosure. The plurality of battery packs 50 are provided in the battery rack 10.

For the detailed description of the battery pack 50 and the battery rack 10, reference may be made to the detailed description of the battery pack 50 and the battery rack 10 in the above embodiments of the present disclosure, which will not be repeated herein.

It should be noted that the energy storage container 1 can further include components such as electrical compartments, and a specific energy storage container may include more components than those described in the embodiments of the present disclosure, or combine some components, or have different component arrangements.

What is claimed is:

1. A bracket assembly applied to a battery rack, the battery rack further comprising a battery rack main body; the battery rack main body being provided with multiple layers of battery storage areas for placing battery packs; the bracket assembly comprises a plurality of first brackets;
wherein the plurality of first brackets are arranged in the multiple layers of battery storage areas, wherein each of the battery storage areas is mounted with a plurality of the first brackets; the plurality of the first brackets in a same battery storage area are arranged in multiple columns and multiple rows, and configured to support and fix a plurality of the battery packs;
two adjacent first brackets in the same row are arranged in a staggered manner, so that two adjacent battery packs in the same row are provided in a staggered manner.

2. The bracket assembly according to claim 1, wherein the first bracket is of a long strip structure and provided with a first panel and a second panel;
wherein the first panel extends along a length direction of the first bracket, and is configured to support a side of the battery pack;
the second panel is provided at a first end of the first bracket and is bent with respect to the first panel, the second panel is configured to abut against a first end of the battery pack;
wherein the plurality of the first support members in the same battery storage area are arranged in two columns and multiple rows, and the first ends of two adjacent first support members in the same row are close to each other and arranged in a staggered manner.

3. The bracket assembly according to claim 2, wherein the second panel is provided with a snap fitting member; wherein the snap fitting member is configured to snap fit with a snap fitting slot provided on the first end of the battery pack.

4. The bracket assembly according to claim 3, wherein the snap fitting member comprises a first snap fitting section and a second snap fitting section; wherein a second end of the first snap fitting section is connected to a first end of the second snap fitting section, and a second end of the second snap fitting section is provided on the second panel;
wherein a first end of the first snap fitting section is smaller in size than the second end of the first snap fitting section.

5. The bracket assembly according to claim 3, wherein the first bracket is further provided with a third panel and a fourth panel extending along the length direction of the first bracket and bent from two opposite sides of the first panel;
wherein the third panel, the fourth panel and the first panel enclose to form a limiting slot; wherein the limiting slot is configured to limit the side of the battery pack; the limiting slot is further configured to guide the battery pack to move toward the second panel during an installation of the battery pack, so that the snap fitting slot on the first end of the battery pack is snapped into the snap fitting member of the second panel.

6. The bracket assembly according to claim 1, wherein the first bracket is of a long strip structure and provided with a first panel, a third panel and a fourth panel each extending along a length direction of the first bracket;
wherein the first panel is configured to support a side of the battery pack;
the third panel and the fourth panel are bent from two opposite sides of the first panel; wherein the third panel, the fourth panel and the first panel enclose to form a limiting slot; wherein the limiting slot is configured to limit the side of the battery pack; the limiting slot is further configured to guide the battery pack to move during an installation of the battery pack.

7. The bracket assembly according to claim 6, wherein the first bracket further comprises a cushioning member, wherein the cushioning member is provided on an inner wall of at least one of the third panel and the fourth panel, and the cushioning member is located between the inner wall and the battery pack.

8. The bracket assembly according to claim 5, wherein the first bracket further comprises a cushioning member, wherein the cushioning member is provided on an inner wall of at least one of the third panel and the fourth panel, and the cushioning member is located between the inner wall and the battery pack.

9. The bracket assembly according to claim 2, wherein the first bracket is further provided with a plurality of connecting portions configured to connect the first bracket to the battery rack main body, wherein the plurality of connecting portions protrude from the first panel.

10. The bracket assembly according to claim 9, wherein one of the connecting portions is arranged adjacent to the second panel; wherein the first panel, the second panel, and the connecting portion adjacent to the second panel are enclosed to form an avoidance portion;
wherein the avoidance portion is configured to avoid an adjacent first bracket in the same row.

11. The bracket assembly according to claim 1, further comprising a support block;
wherein a first end of the support block is connected to the battery rack main body, and a second end of the support block is connected to the first bracket.

12. A battery rack, comprising a battery rack main body and the bracket assembly according to claim 1; wherein the battery rack main body is provided with multiple layers of bracket mounting layers; wherein two adjacent layers of bracket mounting layers enclose to form the battery storage area; a top surface and a bottom surface of a same bracket mounting layer are respectively provided with a plurality of the first brackets;
the first brackets located on the top surface of one bracket mounting layer in the same battery storage area is configured to install one side of the battery pack, and the first bracket located on the bottom surface of another bracket mounting layer in the same battery storage area is configured to install an opposite side of the battery pack.

13. The battery rack according to claim 12, wherein the battery rack main body further comprising a support frame, wherein the plurality of bracket mounting layers are installed parallel to each other on the support frame.

14. The battery rack according to claim 12, wherein the first bracket is of a long strip structure and provided with a first panel and a second panel;
wherein the first panel extends along a length direction of the first bracket, and is configured to support a side of the battery pack;
the second panel is provided at a first end of the first bracket and is bent with respect to the first panel, the second panel is configured to abut against a first end of the battery pack;
wherein the plurality of the first support members in the same battery storage area are arranged in two columns and multiple rows, and the first ends of two adjacent first support members in the same row are close to each other and arranged in a staggered manner.

15. The battery rack according to claim 13, wherein the second panel is provided with a snap fitting member; wherein the snap fitting member is configured to snap fit with a snap fitting slot provided on the first end of the battery pack.

16. The battery rack according to claim 13, wherein the snap fitting member is of a tapered structure, wherein one end of the snap fitting member away from the second panel is smaller in size than an opposite end of the snap fitting member connected to the second panel.

17. The battery rack according to claim 15, wherein the first bracket is further provided with a third panel and a fourth panel extending along the length direction of the first bracket and bent from two opposite sides of the first panel;
wherein the third panel, the fourth panel and the first panel enclose to form a limiting slot; wherein the limiting slot is configured to limit the side of the battery pack; the limiting slot is further configured to guide the battery pack to move toward the second panel during an installation of the battery pack, so that the snap fitting slot on the first end of the battery pack is snapped into the snap fitting member of the second panel.

18. The battery rack according to claim 12, wherein the first bracket is of a long strip structure and provided with a first panel, a third panel and a fourth panel each extending along a length direction of the first bracket;
wherein the first panel is configured to support a side of the battery pack;
the third panel and the fourth panel are bent from two opposite sides of the first panel; wherein the third panel, the fourth panel and the first panel enclose to form a limiting slot; wherein the limiting slot is configured to limit the side of the battery pack; the limiting slot is further configured to guide the battery pack to move during an installation of the battery pack.

19. The battery rack according to claim 18, wherein the first bracket further comprises a cushioning member, wherein the cushioning member is provided on an inner wall of at least one of the third panel and the fourth panel, and the cushioning member is located between the inner wall and the battery pack.

20. An energy storage container, comprising a plurality of battery packs and the battery rack according to claim 12, wherein the plurality of battery packs are provided on the battery rack.
